(19) United States
(12) Patent Application Publication
(10) Pub. No.: US 2022/0405613 A1
(43) Pub. Date: Dec. 22, 2022

(54) FEATURE SELECTION USING TESTING DATA

(71) Applicant: International Business Machines Corporation, Armonk, NY (US)

(72) Inventors: Si Er Han, Xi'an (CN); Jing Xu, Xi'an (CN); Xue Ying Zhang, Xi'an (CN); Jing James Xu, Xi'an (CN)

(21) Appl. No.: 17/350,034

(22) Filed: Jun. 17, 2021

(51) Int. Cl. G06N 5/04; G06N 20/00

(52) U.S. Cl. CPC G06N 5/04; G06N 20/00

(57) ABSTRACT

An approach is provided in which a method, system, and program product perform a distribution test on a plurality of datasets corresponding to a plurality of predictive features. Each of the plurality of datasets comprises a set of training entries corresponding to a selected one of the plurality of predictive features and a set of testing entries corresponding to the selected predictive feature. The method, system, and program product partition the plurality of predictive features into a differential feature set and a consistent feature set based on their corresponding distribution test. The method, system, and program product generate a final feature set based on the differential feature set and the consistent feature set.

### BACKGROUND

Machine learning algorithms build machine learning models based on sample data, known as training data, to make predictions or decisions without being explicitly programmed. The process of training a machine learning model involves providing a machine learning algorithm with the training data from which to learn, and the artifact created from the training process is the machine learning model. The training data includes correct answers that are referred to as targets or target attributes, and the machine learning algorithm finds patterns in the training data that map input data attributes to the target attributes and outputs a machine learning model that captures the patterns.

In machine learning, feature selection is a process that identifies and removes unneeded irrelevant and redundant features from data that do not contribute to the accuracy of a predictive model. Three approaches are generally utilized for feature selection based on a training dataset in which a target variable is present. The three approaches are a filter-based approach, a wrapper approach, and an embedded approach. A filter-based approach assumes that the features are independent and uses correlation or association between each feature and target to determine whether a feature should be kept or removed from the data set. A wrapper approach attempts to search different combinations of features and then builds models to evaluate the combinations based on model accuracy, such as forward stepwise in a linear model in a regression node. An embedded approach usually introduces additional constraints into the optimization of a predictive model.

Adversarial validation is another approach for feature selection when both training data and testing data are present and the testing data does not include target variables. Using both a training dataset and a testing dataset to select features is beneficial when a pattern of a feature is different between the training dataset and the testing dataset. If only the training dataset is used for feature selection, then a feature selected from the training dataset to build a machine learning model may not be useful to evaluate a testing dataset when the selected feature produces a different pattern between the training dataset and the testing dataset.

Adversarial validation combines the training data with the testing data and creates a pseudo target, which is “0” if the sample is from the training dataset and “1” if the sample is from the testing dataset. This approach then builds a classification model for the pseudo target. Next, the adversarial validation approach removes a feature if the feature has a high importance value in the classification model because, if a feature plays an important role to classify a pseudo target (either the training dataset or the testing dataset), then the distribution of the feature is different in the two data sets and therefore may not be important for the real target.

A challenge found with adversarial validation is that the approach requires building a classification model, which is time consuming. Another challenge found with the adversarial validation approach is that the feature selection results depend on the built classification model. As such, a different classification model may produce a different set of selected features.

### BRIEF SUMMARY

According to one embodiment of the present disclosure, an approach is provided in which a method, system, and program product perform, on multiple datasets, multiple distribution tests that each correspond to one of multiple features. Each of the datasets includes a set of training entries corresponding to a selected one of the predictive features and a set of testing entries corresponding to the selected predictive feature. The method, system, and program product partition the predictive features into a differential feature set and a consistent feature set based on their corresponding distribution test. The method, system, and program product generate a final feature set based on the differential feature set and the consistent feature set. In this embodiment, the method, system, and program product select relevant features using training data and testing data without building a classification model that selects model-dependent features.

According to another embodiment of the present disclosure, an approach is provided in which a method, system, and program product identify a lead feature from the consistent feature set. The method, system, and program product adjust the differential feature set based on a correlation of each feature in the differential feature set to the lead feature. The method, system, and program product generate the final feature set based on the adjusted differential feature set and the consistent feature set. In this embodiment, the method, system, and program product refine the final feature set by removing features corresponding to data entries having different correlations to a lead feature.

According to another embodiment of the present disclosure, an approach is provided in which a method, system, and program product select one of the features in the differential feature set. The method, system, and program product compute a correlation range of the set of training entities based on a correlation between a set of first data values of the set of training entities and the lead feature. The method, system, and program product compute a correlation value of the set of testing entities based on a correlation between a set of second data values of the set of testing entities and the lead feature. The method, system, and program product remove the selected differential feature from the differential feature set in response to determining that the correlation value is outside the correlation range. In this embodiment, the method, system, and program product further refine the final feature set by removing features whose testing entries' correlation to a lead feature is outside a training entries' correlation range to the lead feature.

According to another embodiment of the present disclosure, an approach is provided in which a method, system, and program product add a first one of the predictive features to the differential feature set in response to determining that the first predictive feature produces a first distribution corresponding to the set of training entries that is different from a second distribution corresponding to the set testing entries. In this embodiment, the method, system, and program product identify a set of differential features for further analysis that have different distributions between their corresponding training entries and testing entries.

According to another embodiment of the present disclosure, an approach is provided in which a method, system, and program product add a second one of the predictive features to the consistent feature set in response to determining that the second predictive feature produces a third distribution corresponding to the set of training entries that is equivalent to a fourth distribution corresponding to the set testing entries. In this embodiment, the method, system, and program product select a set of features to include in the final feature set that have similar distributions between training entries and testing entries.

According to another embodiment of the present disclosure, an approach is provided in which a method, system, and program product build a machine learning model using the final feature set. In this embodiment, the method, system, and program product build a machine learning model using the final feature set that is devoid of classification model dependencies.

According to another embodiment of the present disclosure, an approach is provided in which a method, system, and program product select a training dataset that includes multiple features and a target. For each of the features, the method, system, and program product select one of the features and perform a statistical test on the selected feature to determine whether the selected feature is statistically important to the target. The method, system, and program product add the selected feature to the set of predictive features based on the statistical test. In this embodiment, the method, system, and program product identify a set of predictive features for further analysis that are statistically important to training dataset targets.

According to another embodiment of the present disclosure, an approach is provided in which a method, system, and program product select a testing dataset that includes multiple features and is devoid of a target. The method, system, and program product select one of the predictive features and combine one or more of the set of training entries corresponding to the selected predictive feature with one or more of the set of testing entries corresponding to the selected feature into a selected dataset. The method, system, and program product add a data source variable to the selected dataset that indicates a dataset source of each of the entries in the selected dataset. In this embodiment, the method, system, and program product identify the source of each of the dataset entries for further correlation analysis of the training entries to the testing entries.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is an exemplary diagram depicting a system that uses a training dataset and a testing dataset to select a set of features to build a machine learning model;

FIG. 4 is an exemplary flowchart depicting steps taken to select a set of features to build a machine learning model;

FIG. 5 is an exemplary diagram depicting a training dataset and a testing dataset;

FIG. 6 is an exemplary diagram depicting a predictive feature set and a corresponding predictive feature dataset for one of the predictive features in the predictive feature set;

FIG. 7 is an exemplary diagram depicting a system performing statistical distribution tests on predictive features and adding the predictive features to a differential feature set or a consistent feature set based on the statistical distribution tests;

FIG. 8 is an exemplary diagram depicting table entries that include a differential feature value, a lead feature value, and a data source label; and

FIG. 9 is an exemplary diagram depicting examples of different correlations between training dataset entries and testing dataset entries in a differential feature set.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

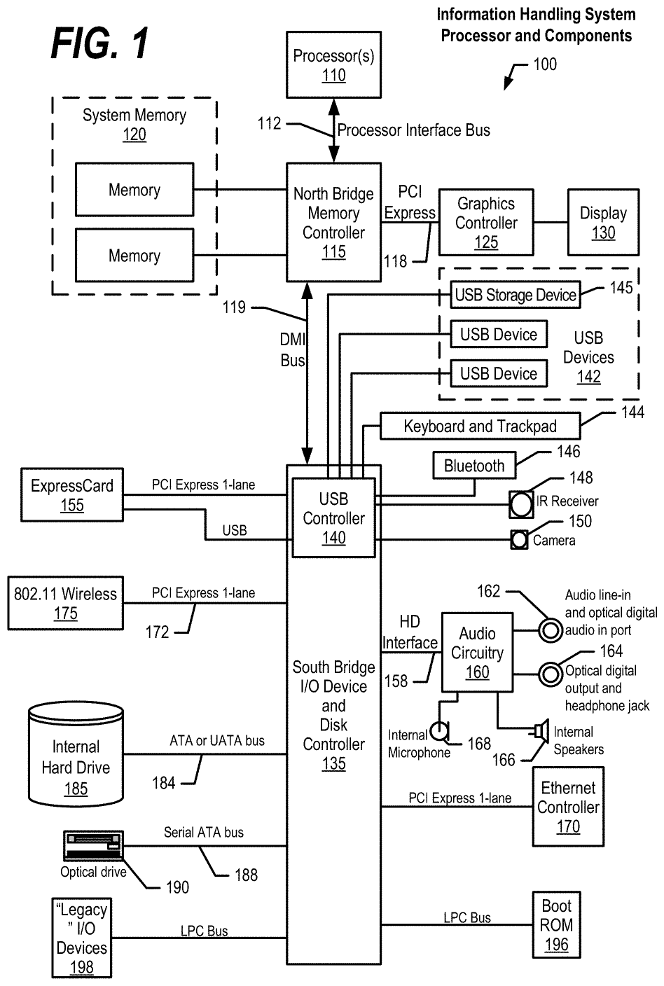

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, Peripheral Component Interconnect (PCI) Express bus 118 connects Northbridge 115 to graphics controller 125. Graphics controller 125 connects to display device 130, such as a computer monitor.

Northbridge 115 and Southbridge 135 connect to each other using bus 119. In some embodiments, the bus is a Direct Media Interface (DMI) bus that transfers data at high speeds in each direction between Northbridge 115 and Southbridge 135. In some embodiments, a PCI bus connects the Northbridge and the Southbridge. Southbridge 135, also known as the Input/Output (I/O) Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and Universal Serial Bus (USB) connectivity as it connects to Southbridge 135 using both the USB and the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, Integrated Services Digital Network (ISDN) connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the Institute of Electrical and Electronic Engineers (IEEE) 802.11 standards of over-the-air modulation techniques that all use the same protocol to wireless communicates between information handling system 100 and another computer system or device. Optical storage device 190 connects to Southbridge 135 using Serial Analog Telephone Adapter (ATA) (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality associated with audio hardware such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, Automated Teller Machine (ATM), a portable telephone device, a communication device or other devices that include a processor and memory.

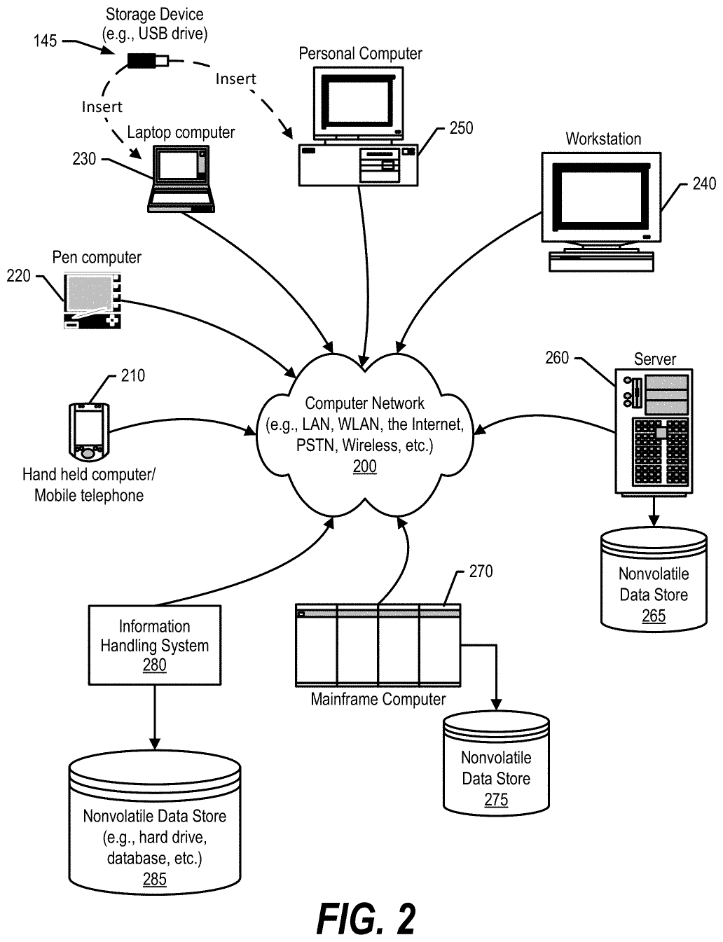

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as Moving Picture Experts Group Layer-3 Audio (MP3) players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. The embodiment of the information handling system shown in FIG. 2 includes separate nonvolatile data stores (more specifically, server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

As discussed above, although an adversarial validation approach considers training data and testing data during feature selection, challenges found with the adversarial validation approach are that the adversarial validation approach requires resources to build a classification model and the feature selection results depend on the classification model. As such, different classification models may produce a different set of feature selections.

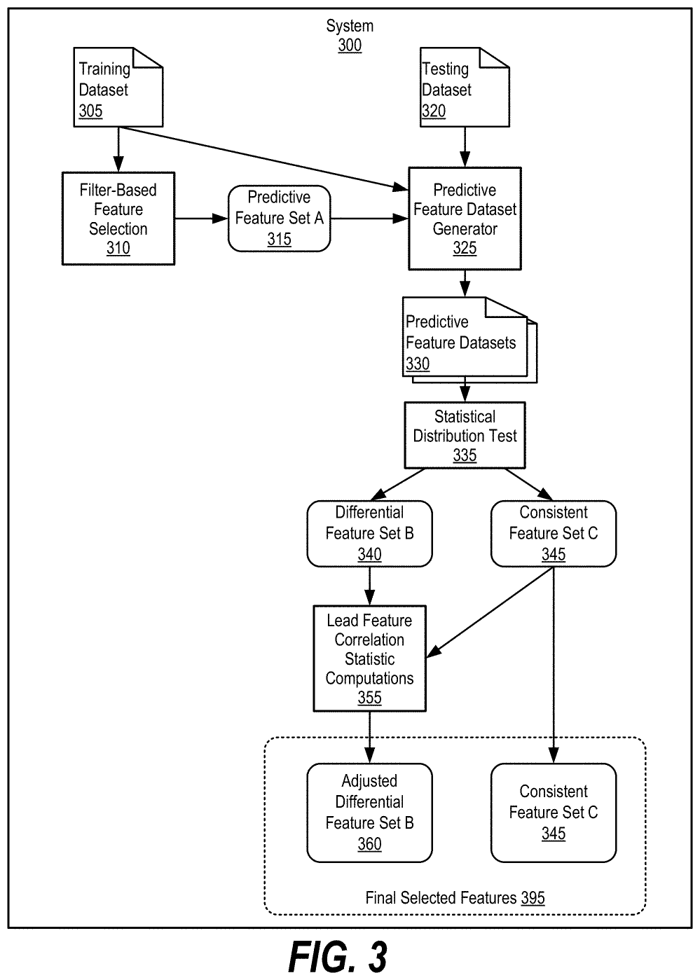

Considering the drawbacks of the adversarial validation approach, FIGS. 3 through 9 depict an approach that can be executed on an information handling system that uses basic statistical tests to efficiently select features and provide consistent, stable feature selection results. The approach uses a filter-based method on training data to select a predictive feature set and then performs statistical tests on each feature in the predictive feature set to check whether the feature's distribution is different between the training dataset and the testing dataset. If a difference in distribution exists, the approach assigns the feature to a differential feature set. If the distributions are similar between the training dataset and the testing dataset, the approach assigns the feature to a consistent feature set.

Then, for the differential feature set, the approach further examines the correlation between each feature and a “lead feature” in the consistent feature set where the lead feature is the feature most important to the target. Then, the approach checks whether the correlation to the lead feature is different between training entries and testing entries in the differential feature set. If the correlation is different, the feature is removed from the differential feature set. In turn, the differential feature set and the consistent feature set are output as a final feature set that the approach uses to build a machine learning model.

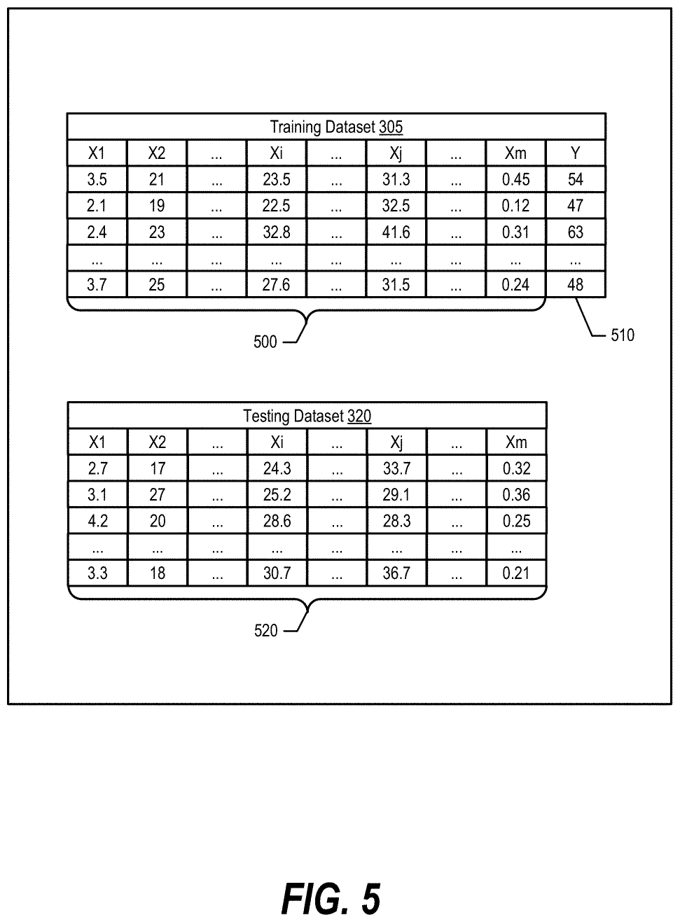

FIG. 3 is an exemplary diagram depicting a system that uses a training dataset and a testing dataset to select a set of features to build a machine learning model. As discussed in detail below, system 300 uses training dataset 305 and testing dataset 320 to select final selected features 395 for machine learning model building. Training dataset 305 includes features X1, X2, . . . Xm and one target variable Y, and testing dataset 320 includes features X1, X2, . . . Xm but no target variable (see FIG. 5 and corresponding text for further details).

System 300 performs filter-based feature selection 310 on training dataset 305. Filter-based feature selection 310 performs a statistical test for each feature Xi in training dataset 305 to determine if the particular feature is important to the target Y, such as by using a Pearson correlation between two features, where a large absolute value result indicates an important feature. Based on filter-based feature selection 310, system 300 adds the important features to predictive feature set A 315.

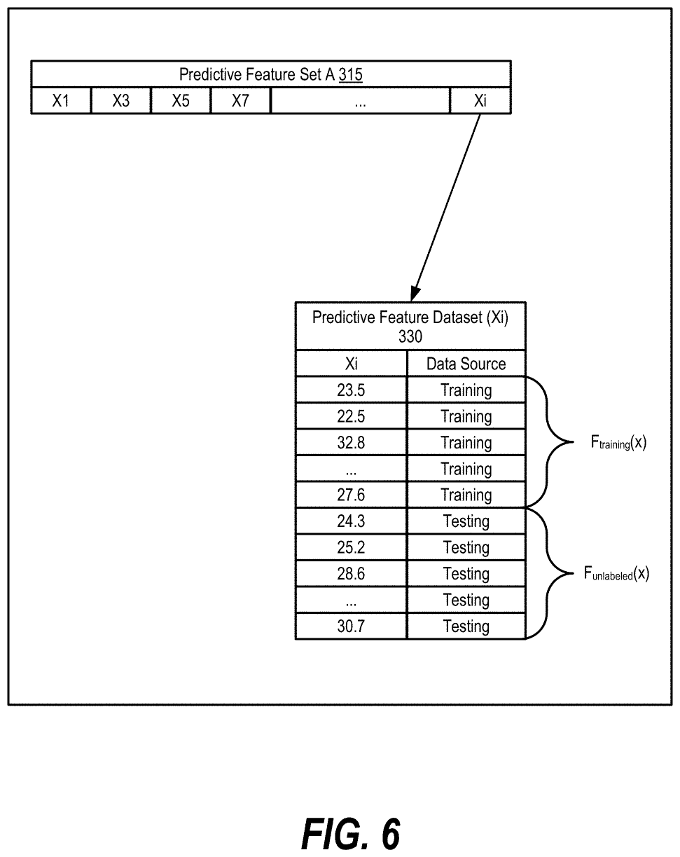

Next, system 300 uses predictive feature dataset generator 325 to generate predictive feature datasets 330. For a selected feature Xi in predictive feature set A 315, predictive feature dataset generator 325 combines the corresponding feature Xi entry values from training dataset 305 and testing dataset 320. In addition predictive feature dataset generator 325 creates a variable “Data Source” to indicate whether an entry value of Xi is from training dataset 305 or testing dataset 320 (see FIG. 6 and corresponding text for further details).

Then, system 300 performs statistical distribution test 335 to test whether the value distribution of Xi on training dataset 305 is different from the value distribution of Xi on testing dataset 320. In one embodiment, referring to FIG. 6, system 300 determines whether there is a significant difference between the distribution Ftraining(x) and Funlabeled(x). In one embodiment, system 300 uses statistical approaches to determine if two distributions have significant difference, such as by using two independent KS(Kolmogorov— Smirnov) tests to compute the difference |Ftraining(x)−Funlabeled(x)|. Then, based on the difference, system 300 computes a p-value (probability value) for the difference and, if the p-value is less than a significant level (e.g., 0.05), then the test indicates that there is significant difference between Ftraining(x) and Funlabeled(x). Otherwise, there is no significant difference between the two distributions.

When system 300 determines a significant difference between the two distributions, then system 300 adds the feature to differential feature set B 340 for further evaluation on whether the feature is actually important to the target Y. If there is not a significant difference (e.g., equivalent distributions), then system 300 adds the feature to consistent feature set C 345.

System 300 then identifies the most important feature (Xj) to target Y in consistent feature set C 345 based on a correlation or association between feature (Xj) and target (Y). The most important feature (Xj) is referred to herein as the “Lead Feature.” Then, for each feature Xi in differential feature set B 340, system 300 performs lead feature correlation statistic computations 355 on both the training entries and the testing entries to determine the correlation or association statistic between Xi and Xj and its confidence interval in the training dataset.

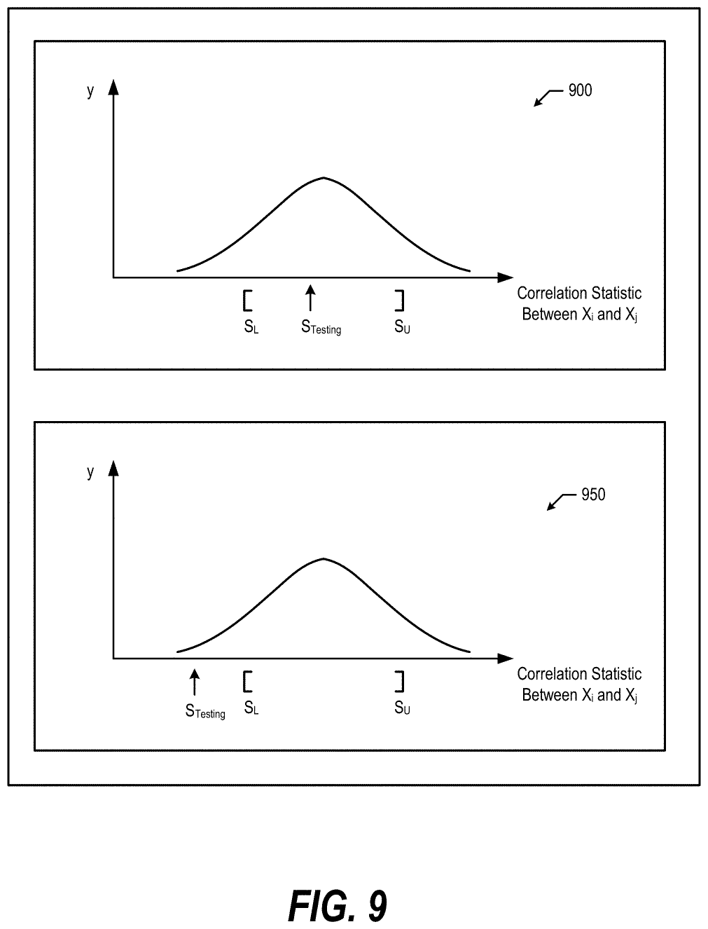

If the testing dataset correlation is out of the range of the training dataset correlation, then system 300 determines that the relationship between Xi and Xj in the testing dataset is different from the relationship between Xi and Xj in the training dataset. As such, system 300 removes the feature from differential feature set B 340 to create adjusted differential feature set B 360 (see FIG. 9 and corresponding text for further details). If the testing dataset correlation is within the range of the training dataset correlation, then system 300 keeps the feature in differential feature set B 340. System 300 then creates adjusted different feature set B 360 that omits the features that do not produce a correlation within the respective training dataset correlation range.

System 300 then combines adjusted differential feature set B 360 and consistent feature set C 345 as final selected features 395 upon which to build a machine learning model. Consistent feature set C 365 includes features that have statistical consistency between training dataset 305 and testing dataset 320 and provide predictive influence to a specified target. Adjusted differential feature set B 360 includes features that have a stable correlation/association among important predictors as discussed herein.

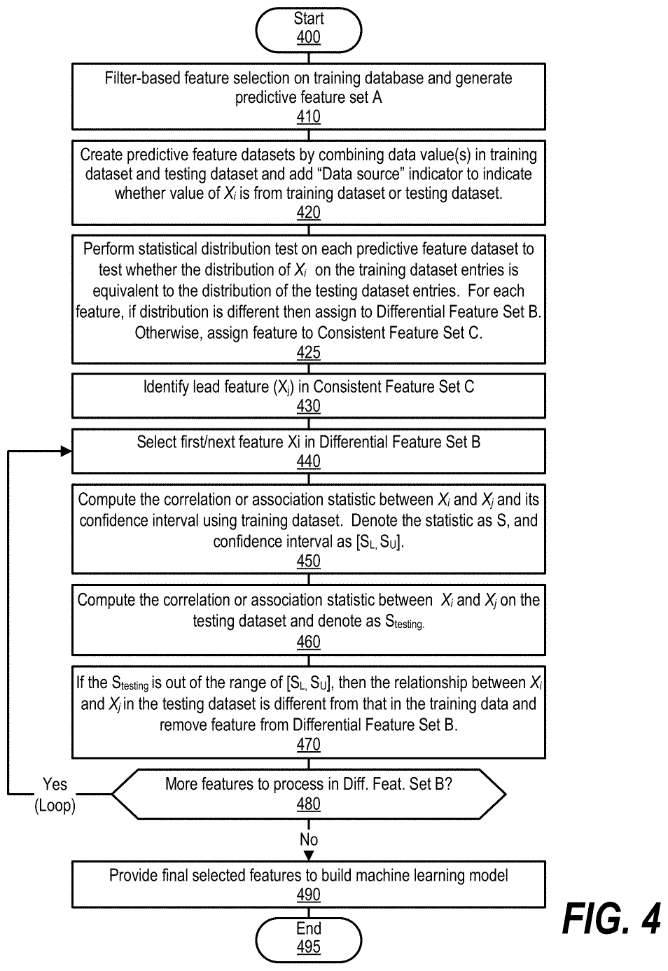

FIG. 4 is an exemplary flowchart depicting steps taken to select a set of features to build a machine learning model. FIG. 4 processing commences at 400 whereupon, at step 410, the process performs filter-based feature selection on training database 305 and generates predictive feature set A 315. At step 420, for each feature Xi in predictive feature set A 315, the process creates one of predictive feature datasets 330 by combining data value(s) from training dataset 305 with testing dataset 320, and includes a variable “Data Source” to indicate whether the value of Xi is from training dataset 305 or testing dataset 320 (see FIG. 6 and corresponding text for further details).

At step 425, for each one of the predictive feature datasets, the process performs a statistical distribution test to test whether the distribution of Xi on the training data values is different from that on the testing data values. For each feature, if the distribution is different, then the process assigns the feature to differential feature set B 340. If the distribution is similar, then the process assigns the feature to consistent feature set C 345.

At step 430, the process identifies a lead feature Xj in consistent feature set C 345 and, at step 440, the process selects the first feature Xi in differential feature set B 340. At step 450, the process computes a correlation or association statistic between the selected Xi and Xj and its confidence interval using training dataset entries in differential feature set B 340. In one embodiment, the process denotes the statistic as S and the confidence interval as [SL, SU].

In one embodiment, the process computes a statistic value S that changes when the computation is based on different sample data. As such, the statistic S follows a probability distribution and, based on the distribution, the process obtains a confidence interval at a confidence level (see FIG. 9 and corresponding text for further details). For example, the process may use a Pearson correlation as a statistic “S” between feature Xi and feature Xj. In this embodiment, the statistic follows a probability distribution and the confidence interval [SL, SU] and a confidence level is obtained based on the distribution. In this embodiment, if the confidence level is 90%, then the SL and SU are at the 5th and 95th percentile of the distribution of S.

At step 460, the process computes the correlation or association statistic between Xi and Xj on the testing dataset entries in differential feature set B 340 and denotes the output as “Stesting.” At step 470, if Stesting is out of the range of [SL, SU], then the relationship between Xi and Xj in the testing dataset is different from that in the training dataset and the process removes the feature from differential feature set B 340.

In one embodiment, in the testing dataset, the process computes a statistic Stesting and, if the distribution of Stesting from the testing dataset is the same as S from the training dataset, then Stesting falls into the confidence interval [SL, SU] with a probability of confidence level (usually is 90%). However, if Stesting is out of the range, then the distribution of Stesting is different from the distribution of S. Therefore, the process computes the confidence interval from the training dataset and a statistic from the testing dataset. The process then determines if the relationship between two features Xi and Xj are the same in the training dataset and testing dataset by judging if the statistics from the testing dataset fall into the confidence interval from the training dataset.

The process determines as to whether there are more features to process in differential feature set B 340 (decision 480). If there are more features to process in differential feature set B 340, then decision 480 branches to the ‘yes’ branch which loops back to select and process the next feature. This looping continues until there are no more features to process in differential feature set B 340, at which point decision 480 branches to the ‘no’ branch exiting the loop.

At step 490, the process provides final selected features 395 to build a machine learning model that includes adjusted differential feature set B 360 and consistent feature set C 345. FIG. 4 processing thereafter ends at 495.

FIG. 5 is an exemplary diagram depicting a training dataset and a testing dataset. Training dataset 305 includes a list of features 500 X1 through Xm and a target output Y 510. Testing dataset 320 includes a similar list of features 520 X1 through Xm, but does not include a target output. As discussed herein, system 300 uses both training dataset 305 and testing dataset 320 to select a set of features to build a machine learning model.

FIG. 6 is an exemplary diagram depicting predictive feature set A 315 and a corresponding predictive feature dataset 330 for one of the predictive features in predictive feature set A 315. System 300 performs filter-based feature selection 310 on training dataset 305 and, for each feature Xi, system 300 performs a statistical test to determine if the particular feature is important to the target Y. If the particular feature is important, then system 300 adds the feature to predictive feature set A 310. The example in FIG. 6 shows that features X1, X3, X5, X7, . . . , and Xi are determined to be important features.

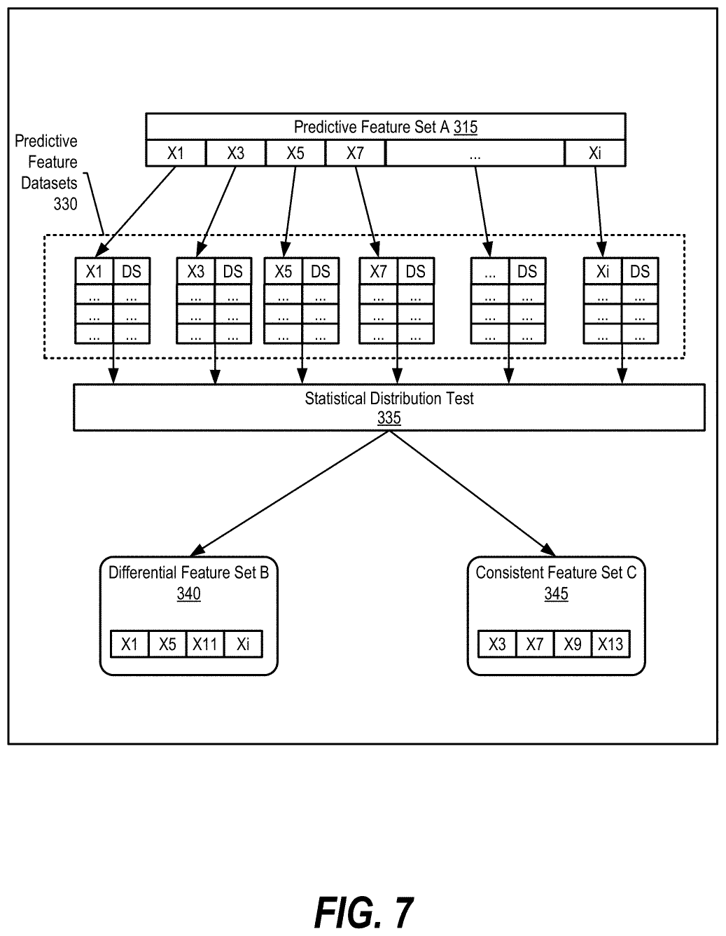

Then, system 300 generates predictive feature datasets 330 for each feature in predictive feature set A 315. FIG. 6 shows an example of predictive feature dataset 330 for feature Xi, which includes data entry values in training dataset 305 and testing dataset 320, and includes a variable “Data Source” to indicate whether a data entry value of Xi is from training dataset 305 or testing dataset 320. FIG. 6 denotes the distribution of training entries as “Ftraining(x)” and denotes the distribution of testing entries “Funlabeled(x).” In turn, system 300 performs statistical distribution tests in the data entries to determine whether to place the feature in differential feature set B 340 or consistent feature set C 345 (see FIG. 7 and corresponding text for further details).

FIG. 7 is an exemplary diagram depicting a system performing statistical distribution tests on predictive features and adding the predictive features to a differential feature set or a consistent feature set based on the statistical distribution tests.

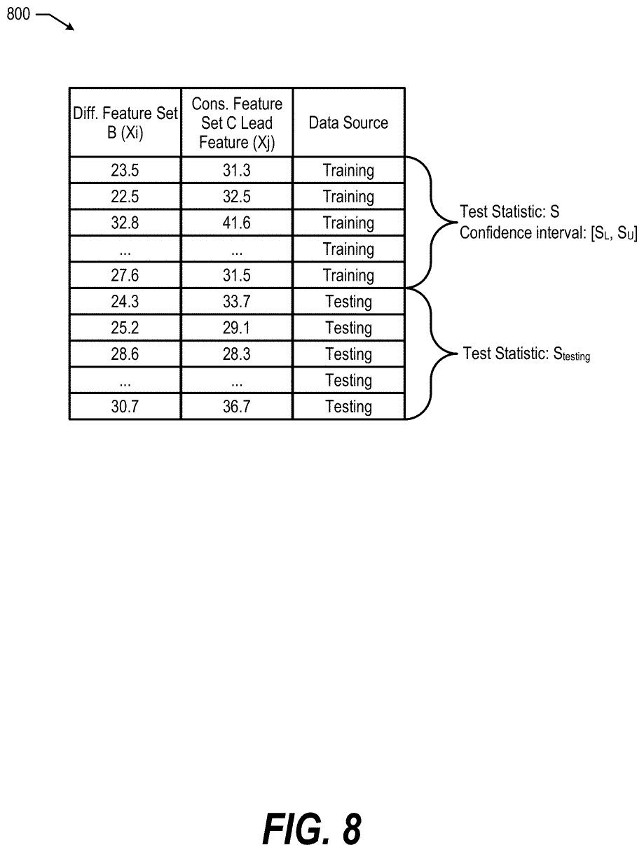

As discussed herein, system 300 performs statistical distribution test 335 to test whether the distribution of each of the feature values in training dataset 305 is different from that in testing dataset 320. Referring back to FIG. 6, system 300 determines whether there is a significant difference between the distribution Ftraining(x) and Funlabeled(x). If there is a significant difference, then system 300 adds the feature to differential feature set B 340 for further evaluation on whether the feature is actually important to the target Y (see FIGS. 8, 9, and corresponding text for further details). If there is not a significant difference, then system 300 adds the feature to consistent feature set C 345.

FIG. 8 is an exemplary diagram depicting table entries that include a differential feature value, a lead feature value, and a data source label. During lead feature correlation statistic computations 355, system 300 identifies lead features (Xj) in consistent feature set C 345 that are the most important features to target Y based on statistical distribution test 335. Then, in one embodiment, system 300 generates table 800 that includes entries that map a feature Xi in differential feature set B 340 to the identified lead feature Xj.

System 300 then uses table 800 to perform lead feature correlation statistic computations 355 and determine the correlation or association statistic between Xi and Xj and its confidence interval (see FIG. 9 and corresponding text for further details).

FIG. 9 is an exemplary diagram depicting examples of different correlations between training entries and testing entries in differential feature set B 340. As discussed above, for each feature Xi in differential feature set B 340, system 300 performs lead feature correlation statistic computations 355 to determine the correlation or association statistic between Xi and Xj and its confidence interval using training dataset 305 denoting the statistic as S, and confidence interval as [SL, SU]. Similarly, system 300 computes the correlation or association statistic between Xi and Xj on the testing dataset, denoted as Stesting.

If the Stesting result is in range of [SL, SU] (graph 900), then system 300 determines that the relationship between Xi and Xj in the testing dataset is similar to that in the training dataset, and system 300 keeps the feature in differential feature set B 340. However, if the Stesting is out of the range of [SL, SU] (graph 950), then system 300 determines that the relationship between Xi and Xj in the testing dataset is different from that in the training dataset, and system 300 removes the feature from differential feature set B 340.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A computer-implemented method comprising:
performing, on a plurality of datasets, a plurality of distribution tests that each correspond to one of a plurality of predictive features, wherein each of the plurality of datasets comprises a set of training entries corresponding to a selected one of the plurality of predictive features and a set of testing entries corresponding to the selected predictive feature;
partitioning the plurality of predictive features into a differential feature set and a consistent feature set based on their corresponding distribution test; and
generating a final feature set based on the differential feature set and the consistent feature set.

2. The method of claim 1 further comprising:
identifying a lead feature from the consistent feature set;
adjusting the differential feature set based on a correlation of each feature in the differential feature set to the lead feature; and
generating the final feature set based on the adjusted differential feature set and the consistent feature set.

3. The method of claim 2 wherein the adjusting further comprises:
selecting one of the features in the differential feature set;
computing a correlation range of the set of training entities based on a correlation between a set of first data values of the set of training entities and the lead feature;
computing a correlation value of the set of testing entities based on a correlation between a set of second data values of the set of testing entities and the lead feature; and
removing the selected differential feature from the differential feature set in response to determining that the correlation value is outside the correlation range.

4. The method of claim 1 wherein the partitioning further comprises:
adding a first one of the plurality of predictive features to the differential feature set in response to determining that the first predictive feature produces a first distribution corresponding to the set of training entries that is different from a second distribution corresponding to the set testing entries.

5. The method of claim 4 further comprising:
adding a second one of the plurality of predictive features to the consistent feature set in response to determining that the second predictive feature produces a third distribution corresponding to the set of training entries that is equivalent to a fourth distribution corresponding to the set testing entries.

6. The method of claim 1 further comprising:
building a machine learning model using the final feature set.

7. The method of claim 1 further comprising:
selecting a training dataset comprising a plurality of features and a target, wherein the training dataset comprises the set of training entries;
for each of the plurality of features:
selecting one of the plurality of features;
performing a statistical test on the selected feature to determine whether the selected feature is statistically important to the target; and
adding the selected feature to plurality of predictive features based on the statistical test.

8. The method of claim 7 further comprising:
selecting a testing dataset comprising the plurality of features and is devoid of the target, wherein the testing dataset comprises the set of testing entries;
selecting one of the plurality of predictive features;
combining one or more of the set of training entries corresponding to the selected predictive feature with one or more of the set of testing entries corresponding to the selected feature into a selected one of the plurality of datasets; and
adding a data source variable to the selected dataset that indicates a dataset source of each of the entries in the selected dataset.

9. An information handling system comprising:
one or more processors;
a memory coupled to at least one of the processors;
a set of computer program instructions stored in the memory and executed by at least one of the processors in order to perform actions of:
performing, on a plurality of datasets, a plurality of distribution tests that each correspond to one of a plurality of predictive features, wherein each of the plurality of datasets comprises a set of training entries corresponding to a selected one of the plurality of predictive features and a set of testing entries corresponding to the selected predictive feature;
partitioning the plurality of predictive features into a differential feature set and a consistent feature set based on their corresponding distribution test; and
generating a final feature set based on the differential feature set and the consistent feature set.

10. The information handling system of claim 9 wherein the processors perform additional actions comprising:
identifying a lead feature from the consistent feature set;
adjusting the differential feature set based on a correlation of each feature in the differential feature set to the lead feature; and
generating the final feature set based on the adjusted differential feature set and the consistent feature set.

11. The information handling system of claim 10 wherein the processors perform additional actions comprising:
selecting one of the features in the differential feature set;
computing a correlation range of the set of training entities based on a correlation between a set of first data values of the set of training entities and the lead feature;
computing a correlation value of the set of testing entities based on a correlation between a set of second data values of the set of testing entities and the lead feature; and
removing the selected differential feature from the differential feature set in response to determining that the correlation value is outside the correlation range.

12. The information handling system of claim 9 wherein the processors perform additional actions comprising:
adding a first one of the plurality of predictive features to the differential feature set in response to determining that the first predictive feature produces a first distribution corresponding to the set of training entries that is different from a second distribution corresponding to the set testing entries.

13. The information handling system of claim 12 wherein the processors perform additional actions comprising:
adding a second one of the plurality of predictive features to the consistent feature set in response to determining that the second predictive feature produces a third distribution corresponding to the set of training entries that is equivalent to a fourth distribution corresponding to the set testing entries.

14. The information handling system of claim 9 wherein the processors perform additional actions comprising:
building a machine learning model using the final feature set.

15. The information handling system of claim 9 wherein the processors perform additional actions comprising:
selecting a training dataset comprising a plurality of features and a target, wherein the training dataset comprises the set of training entries;
for each of the plurality of features:
selecting one of the plurality of features;
performing a statistical test on the selected feature to determine whether the selected feature is statistically important to the target; and
adding the selected feature to plurality of predictive features based on the statistical test.

16. The information handling system of claim 15 wherein the processors perform additional actions comprising:
selecting a testing dataset comprising the plurality of features and is devoid of the target, wherein the testing dataset comprises the set of testing entries;
selecting one of the plurality of predictive features;
combining one or more of the set of training entries corresponding to the selected predictive feature with one or more of the set of testing entries corresponding to the selected feature into a selected one of the plurality of datasets; and
adding a data source variable to the selected dataset that indicates a dataset source of each of the entries in the selected dataset.

17. A computer program product stored in a computer readable storage medium, comprising computer program code that, when executed by an information handling system, causes the information handling system to perform actions comprising:
performing, on a plurality of datasets, a plurality of distribution tests that each correspond to one of a plurality of predictive features, wherein each of the plurality of datasets comprises a set of training entries corresponding to a selected one of the plurality of predictive features and a set of testing entries corresponding to the selected predictive feature;
partitioning the plurality of predictive features into a differential feature set and a consistent feature set based on their corresponding distribution test; and
generating a final feature set based on the differential feature set and the consistent feature set.

18. The computer program product of claim 17 wherein the information handling system performs further actions comprising:
identifying a lead feature from the consistent feature set;
adjusting the differential feature set based on a correlation of each feature in the differential feature set to the lead feature; and
generating the final feature set based on the adjusted differential feature set and the consistent feature set.

19. The computer program product of claim 18 wherein the information handling system performs further actions comprising:
selecting one of the features in the differential feature set;
computing a correlation range of the set of training entities based on a correlation between a set of first data values of the set of training entities and the lead feature;
computing a correlation value of the set of testing entities based on a correlation between a set of second data values of the set of testing entities and the lead feature; and
removing the selected differential feature from the differential feature set in response to determining that the correlation value is outside the correlation range.

20. The computer program product of claim 17 wherein the information handling system performs further actions comprising:
adding a first one of the plurality of predictive features to the differential feature set in response to determining that the first predictive feature produces a first distribution corresponding to the set of training entries that is different from a second distribution corresponding to the set testing entries.

21. The computer program product of claim 20 wherein the information handling system performs further actions comprising:
adding a second one of the plurality of predictive features to the consistent feature set in response to determining that the second predictive feature produces a third distribution corresponding to the set of training entries that is equivalent to a fourth distribution corresponding to the set testing entries.

22. The computer program product of claim 17 wherein the information handling system performs further actions comprising:
building a machine learning model using the final feature set.

23. The computer program product of claim 17 wherein the information handling system performs further actions comprising:
selecting a training dataset comprising a plurality of features and a target, wherein the training dataset comprises the set of training entries;
for each of the plurality of features:
selecting one of the plurality of features;
performing a statistical test on the selected feature to determine whether the selected feature is statistically important to the target; and
adding the selected feature to plurality of predictive features based on the statistical test.

24. The computer program product of claim 23 wherein the information handling system performs further actions comprising:
selecting a testing dataset comprising the plurality of features and is devoid of the target, wherein the testing dataset comprises the set of testing entries;
selecting one of the plurality of predictive features;
combining one or more of the set of training entries corresponding to the selected predictive feature with one or more of the set of testing entries corresponding to the selected feature into a selected one of the plurality of datasets; and
adding a data source variable to the selected dataset that indicates a dataset source of each of the entries in the selected dataset.

25. A computer-implemented method comprising:
performing, on a plurality of datasets, a plurality of distribution tests that each correspond to one of a plurality of predictive features, wherein each of the plurality of datasets comprises a set of training entries in a training dataset corresponding to a selected one of the plurality of predictive features and a set of testing entries in a testing dataset corresponding to the selected predictive feature;
partitioning the plurality of predictive features into a differential feature set and a consistent feature set based on their corresponding distribution test;
identifying a lead feature from the consistent feature set;
selecting one of the features in the differential feature set;
computing a correlation range of the set of training entities based on a correlation between data values of the set of training entities and the lead feature;
computing a correlation value of the set of testing entities based on a correlation between data values of the set of testing entities and the lead feature;
in response to determining that the correlation value is outside the correlation range, adjusting the differential feature set by removing the selected differential feature from the differential feature set; and
generating a final feature set based on the adjusted differential feature set and the consistent feature set.
